(19) United States
(12) Patent Application Publication
(10) Pub. No.: US 2002/0142157 A1
(43) Pub. Date: Oct. 3, 2002

(54) Electroconductive adhesive tape

(75) Inventor: Yong-In Lee, Seoul (KR)

Correspondence Address: John S. Egbert, Harrison & Egbert, 412 Main Street, 7th Floor, Houston, TX, 77002, US

(73) Assignee: Shinwha Intertek Corp.

(21) Appl. No.: 09/866,217

(22) Filed: May 29, 2001

(30) Foreign Application Priority Data
Mar. 29, 2001 (KR) 2001-16409

(51) Int. Cl. B32B 15/04; B32B 7/12; B32B 27/04; D04B 21/00; D04G 1/00; D03D 19/00; D04B 1/00

(52) U.S. Cl. 428/343; 428/354; 428/355 N; 442/1; 442/43; 442/20

(57) ABSTRACT

The present invention relates to an electroconductive adhesive tape used for electrical and electronic products to bond or fix an element to a support while maintaining an electrical conductivity between the element and support. The electroconductive adhesive tape comprises a perforated synthetic film, two metal plating layers respectively formed on both surfaces of the synthetic resin film, and a conductive adhesive layer formed on one of the metal plating layers. Made to be very thin, the film has the advantage of being flexible and high in tensile strength in addition to showing excellent electrical conductivity. The metal plating layers are integratedly formed through the perforations of the synthetic resin film, maintaining excellent electrical conductivity. Thus, the electroconductive adhesive tape maintains a desired strength while exhibiting a high flexibility and a high bondability.

### TECHNICAL FIELD AND PRIOR ART

The present invention relates to an electroconductive adhesive tape comprising a perforated synthetic film on both surfaces of which two metal plate layers are deposited, one of them being coated with a conductive adhesive layer. Electroconductive adhesive tapes have numerous applications in a broad range of technical fields associated with electrical and electronic products to bond or fix an element to a support while maintaining an electrical conductibility between the element and support.

Electroconductive adhesive tapes, for example, are usually used in assembling processes for video display appliances such as televisions. In this case, they serve to fix the Braun tube of the television, as well as grounding electrostatic charge and electromagnetic fields accumulatively induced on the outer peripheral surface of the Braun tube, thereby removing the electrostatic charge and electromagnetic fields. Another field to which such electroconductive adhesive tapes are applied is the assemblage of cars and electronic products.

On the whole, a Braun tube comprises an evacuated bulb made of glass, so that it is susceptible to an external impact. For this reason, such a Braun tube is not directly fixed to a casing or housing, but to the casing or housing through a bracket bonded adhesively to the outer peripheral surface of the Braun tube.

In addition to being used in bonding the bracket to the Braun tube, adhesive tapes have a buffering function to prevent the Braun tube from being damaged. Even in the case that the Braun tube explodes due to a severe external impact or other accident, the adhesive tape reduces the flying range of pieces of broken glass.

For this reason, an adhesive tape adapted to fix a bracket to a Braun tube is called an explosion-proof tape. Electrical conductivity provided to such an explosion-proof tape is necessary to additionally prevent electrostatic charge and electromagnetic fields induced on the outer peripheral surface of the Braun tube from being outwardly emitted. To meet the requirement of high tensile strength for such an explosion-proof tape, the base material for the tape adopts a glass fiber net structure.

A very high voltage is applied to the inner surface of a Braun tube used in video display appliances, such as televisions, so as to form an image on that inner surface. As a result, the application of such a very high voltage induces electrostatic charge on the outer surface of the Braun tube. Unless the generated electrostatic charge is removed, the charge is accumulated, forming a magnetic field and an electric field. As a result, electromagnetic waves are outwardly emitted from the Braun tube.

In order to prevent an accumulation of electrostatic charge induced on the Braun tube and to shield electromagnetic waves emitted from the Braun tube, various techniques have been proposed, one of which is to use an electrically conductive adhesive tape to remove the accumulated electrostatic charge via an earth circuit, as illustrated in FIG. 1.

When a Braun tube is assembled, an electroconductive adhesive tape is used to fix the Braun tube directly to an iron bracket. In this regard, an elongated, electroconductive adhesive tape is cut into pieces having a desired length. The conductive adhesive tape pieces are bonded to the outer peripheral surface of a Braun tube while being spaced from one another. An iron bracket 4 is then bonded to the outer peripheral surface of the Braun tube via the conductive adhesive tape pieces while being electrically connected to the conductive adhesive tape pieces. Thus, electrostatic charge induced on the Braun tube is discharged via the bracket to an earth circuit 3 equipped in a cabinet.

Referring to FIG. 2, there is shown a structure of an electroconductive adhesive tape which is typically used for the above mentioned purpose. As shown in FIG. 2, the conductive adhesive tape comprises a conductive metal foil 11, such as copper or aluminum, a conductive adhesive layer 10, and a strippable protective sheet 12. The conductive adhesive tape is used after stripping the protective sheet therefrom.

As shown in FIG. 1, the Braun tube can be divided into several sections. One of them is a display panel section 1 having a conductive surface on its inner surface to display an image. The conductive surface is formed by coating a conductive material 2 such as carbon or conductive ceramic onto the surface of the display panel section 1 using a vapor deposition technique, a sputtering technique or an ion plating technique. Another section comprises a deflection yoke made of an electromagnet, which serves to stabilize an electron beam emitted from the electron gun 9. Around this section, a funnel-shaped metal sheet 8 is mounted in order to shield the electromagnetic waves. Also, electroconductive adhesive tape 7 is attached to desired portions of the remaining outer surface of the Braun tube in order to prevent an accumulation of electrostatic charge induced on the Braun tube and an emission of electromagnetic waves from the Braun tube.

Returning now to FIG. 1, the reference numeral 3 stands for an earth circuit, the reference numeral 4 for an iron bracket, and the reference numeral 5 for a silicon resin layer to insulate the outer surface of the Braun tube from a high-voltage current flowing from an anode denoted by the reference numeral 6. The reference numeral 16 denotes an explosion-proof tape.

For use in the assemblage of Braun tubes, electroconductive adhesive tapes are required to be thin and high in tensile strength, and flexible. That is, the electroconductive adhesive tapes are not destroyed easily, but are able to maintain a good appearance after assemblage. Flexibility is necessary for the tape to show a uniform surface bonding to a curved surface.

A conventional electroconductive tape is structured to have a conductive metal strip, such as aluminum foil or copper foil, attached to a conductive adhesive layer and optionally is subjected to a release process so that it can be rolled without using any strippable protective sheet.

The term “electroconductive or conductive adhesive” as used herein means an adhesive which is prepared by mixing a conductive metal powder with an adhesive material produced by dissolving rubber or an acrylic resin in an organic solvent, and thus exhibiting appropriate conductivity determined according to the added amount of the conductive metal powder.

Examples of the conductive metal powder include copper, aluminum, nickel, chromium, and graphite. The conductive metal powder has a size of 2-5 μm and is added at an amount of about 50 to 200 parts by weight based on 100 parts by weight of the adhesive material.

Conventional conductive adhesive tapes that are structured to have a metal foil layer and a conductive adhesive layer are so poor in flexibility and elongation that they are likely to crumple and tear. Additionally, their poor flexibility lowers the bondability of the conventional conductive adhesive tapes to curved portions.

Since the above-mentioned conventional metal foil has a relatively large thickness of about 20 to 65 μm, it is likely to crumple when being bonded to the iron bracket, which, in turn, results in a poor surface bonding. Furthermore, the tape exhibits a degraded flexibility due to the large thickness of the metal foil. In order to obtain a uniform surface bonding of the tape to a curved surface, it is necessary to apply a certain amount of manual pressure to the tape upon bonding the tape to the curved surface. Otherwise, a separate tool should be used, causing inconvenience. The tape may also be likely to exhibit a degraded appearance due to its easy crumpling property. Such a conductive adhesive tape is usually used where conductivity is required, but no or low tensile strength is necessary. However, such a conductive adhesive tape is too thickly produced due to a large thickness of the metal foil, resulting in an increase in the production cost.

Another type of adhesive tapes can be found in Korean Pat. No. 10-0267814 that discloses a conductive adhesive tape comprising a synthetic resin film which is deposited with a metal layer on which a conductive adhesive is coated. However, this conductive adhesive tape suffers from the problem of being poor in conductivity. Korean Utility Laid-Open Pub. No. 1998-065059 discloses a conductive adhesive tape based on a metal-plated polyester net-shaped structure which is coated with a conductive adhesive. However, the plating of metal to the net-shape structure requires complicated processes.

Therefore, it is an object of the invention to provide an electroconductive adhesive tape which is very thin, flexible and high in tensile strength in addition to showing excellent conductivity.

### BRIEF SUMMARY OF THE INVENTION

The present invention pertains to an electroconductive adhesive tape that comprises a synthetic resin film with circular or square perforations as seen in FIG. 4b or 4c, two metal plating layers deposited on both surfaces of the film, respectively, and a conductive adhesive layer formed on one of the metallic layers.

### BRIEF DESCRIPTION OF THE SEVERAL VIEWS OF THE DRAWINGS

FIG. 1 is an illustration showing an electromagnetic wave shielding structure conventionally applied to a Braun tube in a side view.

FIG. 2 is a cross-sectional view illustrating a conventional electroconductive adhesive tape.

FIG. 3 is a view illustrating the process of forming metal plating layers on both surfaces of a perforated synthetic resin film.

FIG. 4a is a cross-sectional view illustrating an electroconductive adhesive tape of the present invention.

FIGS. 4b and 4c illustrate examples of perforated synthetic resin films useful in the present invention.

FIG. 5 is a cross-sectional view illustrating an electroconductive adhesive tape (explosion- proof tape) employing a glass fiber net.

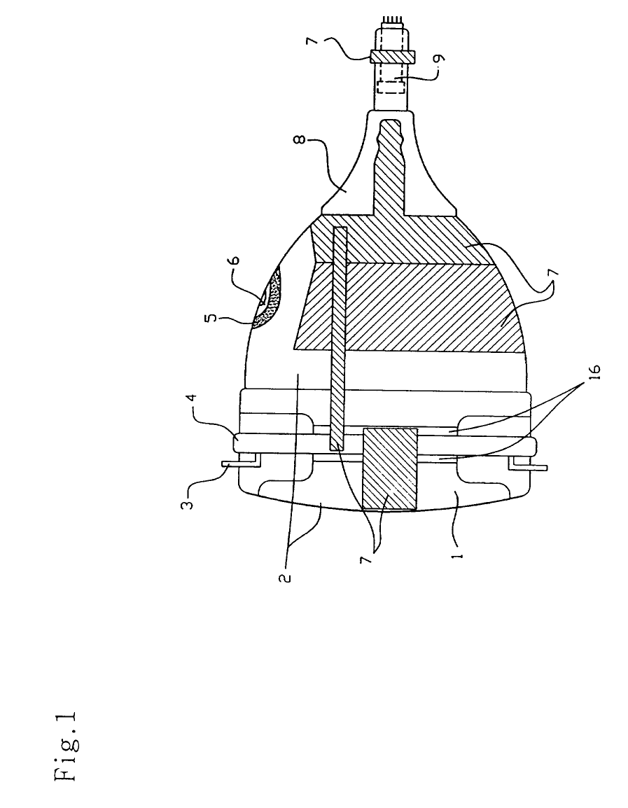

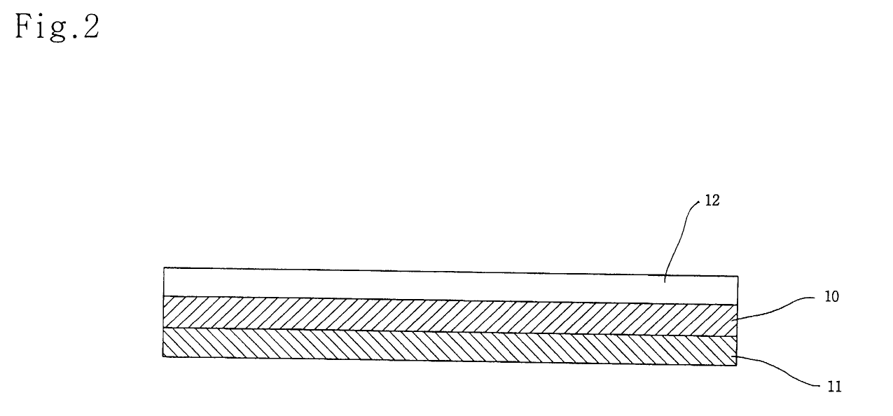

### DETAILED DESCRIPTION OF THE INVENTION

Exemplified by polyethylene, polypropylene, polyethylene terephthalate (hereinafter referred to as “PET”), and nylon, any synthetic resin film that is used as a base in conventional adhesive tapes may be used in the present invention.

Metal useful for the plating layers may be selected from the group consisting of copper, aluminum, brass, tin, nickel, chromium, and silver.

As for the conductive adhesive, it may be a one which is well known in the art. For example, it is made by mixing 50-200 weight parts of a conductive powder 5 μm or smaller in size, selected from copper, nickel, chrome, and graphite, with 100 weight parts of an adhesive material.

In accordance with the present invention, the electroconductive tape has a thickness of 50-100 μm in total, in which the metal plating layer ranges from 1 to 5 μm in thickness while 20-65 μm is assigned to the synthetic resin film and 30-40 μm to the conductive adhesive layer.

The metal plating layer may be formed by use of a vacuum depositing, electroless metal plating, sputtering, ion plating, chemical vapor depositing, or physical vapor depositing method.

The conductive adhesive tape of the present invention is crumpled to a much lesser extent as compared to conventional conductive adhesive tapes including a well-known metal foil. It is also possible to allow the tape to have an optional color in accordance with the selection of an appropriate metal to be deposited. Furthermore, the coating of the conductive adhesive layer over the metal layer prevents oxidation from occurring at the surface of the metal layer with the lapse of time, enjoying the advantage of no reduction in permittivity. In particular, the metal plating layers are integratedly formed through the perforations of the synthetic resin film, maintaining excellent electrical conductivity. The present will now be described in detail with reference to the following example, but the present invention is not to be construed as being limited thereto.

### EXAMPLES

### Electroconductive Adhesive

100 parts by weight of an acrylic adhesive with a solid content of 40% was homogeneously admixed with 50 parts by weight of a copper powder with a mean particle size of 5 μm to give a conductive adhesive. This adhesive is well known in the art.

### PET Film

There was prepared a PET film 20 μm thick. The film was punched to form 4-20 holes per cm². Preferably, the holes ranged from 0.5 to 1.0 mm in size. The holes may be circular or square in shape.

### Preparation of Electroconductive Adhesive Tape

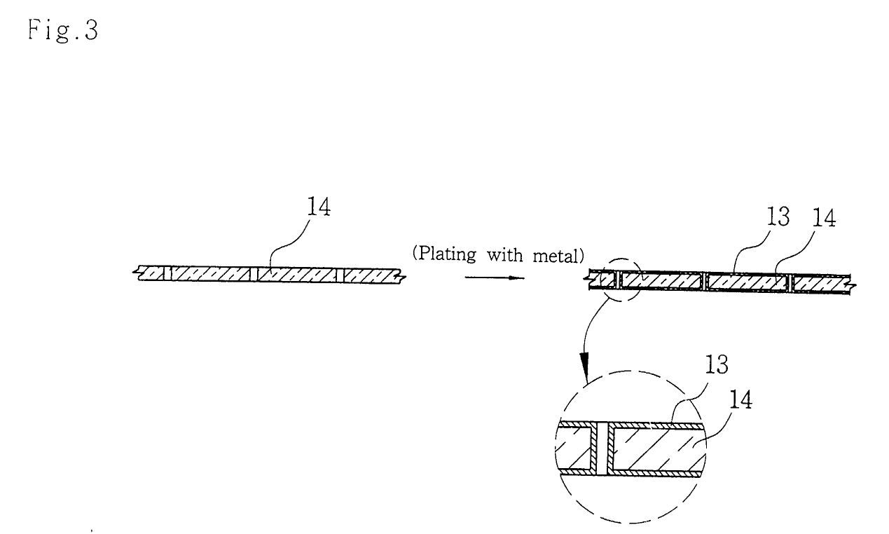

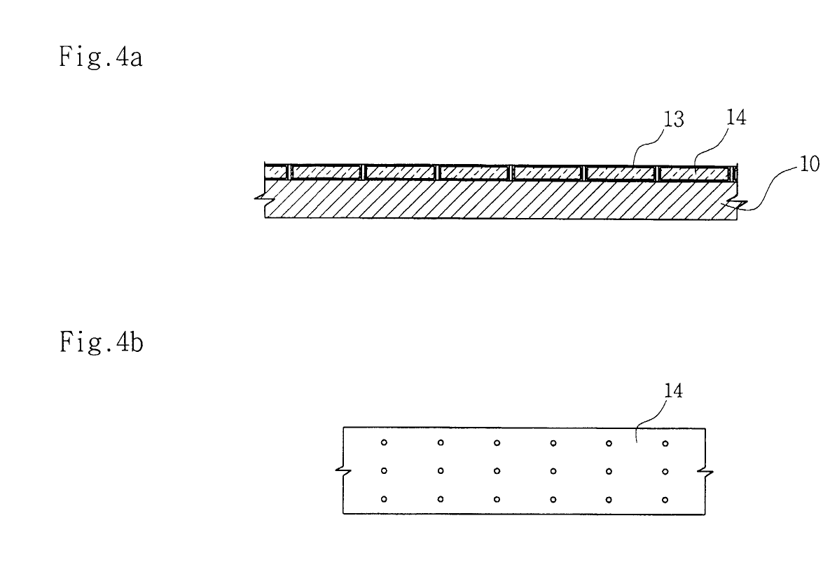

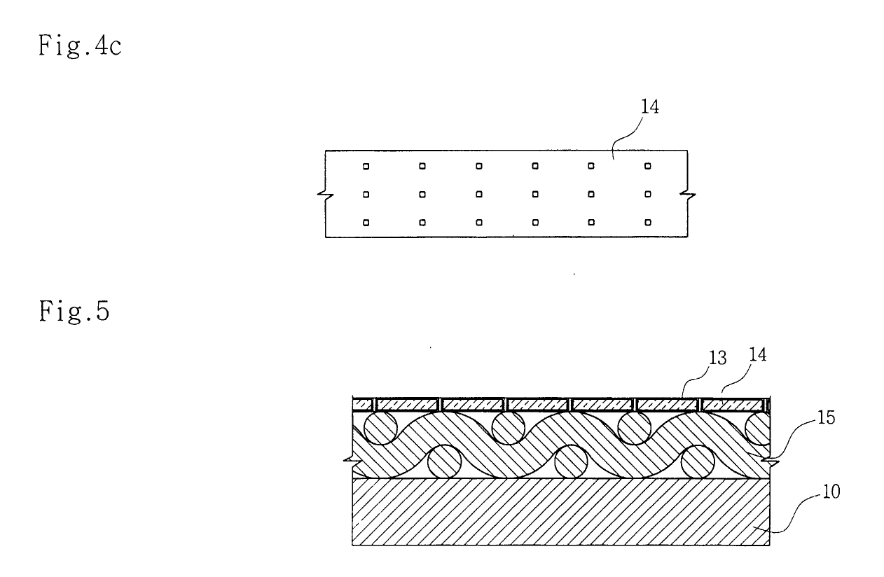

While being moved at a certain speed within a vacuum deposition bath, the perforated PET film was deposited with Al metal under an evaporation condition of the Al metal, as seen in FIG. 3.

The deposition of aluminum was carried out to a thickness of about 3 μm. The method for depositing metal such as aluminum over a synthetic resin film is well known in this technical field.

Thereafter, the conductive adhesive was coated to a thickness of about 30 μm over one surface of the Al-deposited PET film and then dried to afford an electroconductive adhesive tape. The overall thickness of the electroconductive adhesive tape is about 60 μm.

### Preparation of Explosion-Proof Tape

Due to the requirement of high tensile strength, an explosion-proof tape employed a glass fiber net as a base.

On one surface of the metal plate layer-formed PET film obtained above, a glass fiber net was laid, followed by coating the conductive adhesive layer onto the glass fiber net. The resulting explosion-proof tape was based on the fiber glass net and the synthetic resin film.

The electroconductive adhesive tape of the present invention can be made very thin and has the advantage of being flexible and high in tensile strength in addition to showing excellent electrical conductivity.

1. An electroconductive adhesive tape, comprising a perforated synthetic film, two metal plating layers respectively formed on both surface of the synthetic resin film, and a conductive adhesive layer formed on one of the metal plating layers.

2. The electroconductive adhesive tape as set forth in claim 1, wherein said synthetic resin film is made of a material selected from the group consisting of polyethylene, polyethylene terephthalate, polypropylene, and nylon.

3. The electroconductive adhesive tape as set forth in claim 1, wherein said metal layer is made of a metal selected from the group consisting of copper, aluminum, silver, brass, tin, nickel, and chromium.

4. The electroconductive adhesive tape as set forth in claim 1, further comprising a glass fiber net between the metal plating layer and the conductive adhesive layer.
